(19) United States
(12) Patent Application Publication
(10) Pub. No.: US 2016/0187119 A1
(43) Pub. Date: Jun. 30, 2016

(54) Multiple Optical Channel Autocorrelator Based on Optical Circulator

(71) Applicant: Harbin Engineering University, Harbin (CN)

(72) Inventors: Libo YUAN, Heilongjiang (CN); Jun YANG, Heilongjiang (CN); Ai ZHOU, Heilongjiang (CN)

(73) Assignee: Harbin Engineering University, Harbin (CN)

(21) Appl. No.: 15/065,640

(22) Filed: Mar. 9, 2016

Related U.S. Application Data
(62) Division of application No. 13/877,772, filed on Apr. 4, 2013.

(51) Int. Cl. G01B 9/02; G02B 6/293

(52) U.S. Cl. CPC G01B 9/02015; G02B 6/2932; G02B 6/29349

(57) ABSTRACT

A multiple optical channel autocorrelator based on an optical fiber circulator includes a broad-band light source, at least an optical-fiber sensor array, an adjustable multiple light beams generator, at least an optical fiber circulator and at least a photoelectric detector. The optical-fiber sensor array is composed of the sensing fibers connected end to end. The in line mirrors are formed by the connecting end faces of the adjacent fibers. The adjustable multiple light beams generator includes a fixed arm and an adjustable arm. The optical path difference between the fixed arm and the adjustable arm is adjustable in order to match the optical path of each sensor in the sensor array. The optical fiber circulator couples the signals generated by the multiple light beams generator to the sensor array, and couples the signals returned by the sensor array to the photoelectric detector. The photoelectric detector is connected to the optical fiber circulator. The multiple optical channel autocorrelator based on the optical fiber circulator can implement the real-time in line measurement of the physical quantity of multipoint strain or deformation, and has advantages of low light source power loss, high efficiency and good stability.

### CROSS-REFERENCE TO RELATED PATENT APPLICATIONS

This application is a Divisional of U.S. application Ser. No. 13/877,772 (National Stage of PCT/CN2010/001563), filed Apr. 4, 2013, incorporated herein by reference in its entirety.

### TECHNICAL FIELD

The present invention relates to an autocorrelator for sensing and, more particularly relates to a distributed measurement device capable of causing changes of the absolute optical path by stress, strain and temperature, etc.

### BACKGROUND ART

An interferometer which uses a broad-band light as a light source and a fiber as a transmission medium is white-light optical fiber interferometer. The traditional optical fiber white-light interferometer usually includes a sensing arm and an adjustable reference arm, and signals transmitted along the sensing arm and the reference arm are detected by a photodetector. If optical path difference between the sensing arm and the reference arm is less than a coherence length of the light source, interference occurs between two signals. The character of the white light interference fringe is of a main maximum value, called a central fringe, which corresponds to a absolute equal for the optical paths of reference light beam and a measured light beam that is referred to as optical paths match between the reference light beam and the measured light beam. When the optical path of the measuring arm changes, the central interference fringe could be obtained through the change of the optical path of the reference signal caused by the changing the delay amount of the optical fiber delay lines. The location of the central fringe provides a reliable reference of the absolute position in measurement, when the optical path of the measuring light beam changes under the affection of the outside physical amount to be measured, the position change of the white light interference fringe can be obtained simply by the optical path adjustment of the reference arm, thereby obtaining the value of the absolute change in the physical amount being measured. Compared with other fiber interferometer, the most important feature for the white light fiber interferometer is to perform the absolute measurement for stress, strain and temperature, etc., the amount to be measured, in addition to the advantages of high sensitivity, intrinsically safe, anti-electromagnetic interference and so on. Thus, the white light interference fiber interferometer is widely used for the measurements of physical amount, mechanical amount, environment amount, chemical amount, and biomedical amount.

In practice, particularly in the monitor for the building structure, it is generally required to perform a long-distance, multi-point quasi-distributed measurement to the building structure, which requires a longer gauge for the optical fiber sensor. However, for the structure of the conventional optical fiber white light interferometer, the gauge of the sensing fiber is limited by the adjustable distance range in the reference arm. Further, even if the long distance adjustable range can be obtained, the transmission loss of the optical signal in the optical path of the long-distance space will be huge.

In order to solve the above problems, a long distance optical-fiber sensor array is formed by multiplexing a series of short distance fibers with well cut end faces. In the sensor array, each sensor is connected end to end, part mirrors are formed by the connecting end faces of the adjacent sensors, which causes an interference between the reflected signals of the adjacent mirrors.

In 1995, Wayne V. Sorin and Douglas M. Baney of U.S. HP company discloses a multiplexed method for a white light interference sensor based on the optical path autocorrelator (U.S. Pat. No. 5,557,400), based on the structure of the Michelson interrogator, the optical path autocorrelation is implemented by using the optical path difference formed by the optical signals between a fixed arm and a variable scanning arm in the Michelson interrogator, and the match of the optical path difference between two reflected optical signals of two end faces of the front and the rear of the fiber sensor, the white light interference signal of the sensor is obtained, then, by using the size for changing the optical path difference between the scanning arm and the fixed arm, each sensor among the fiber sensor array connected in series end to end is matched one by one, the multiplexing of the fiber sensor is finished.

In addition, the applicant disclosed “Sagnac optical-fiber deformation sensor of low-coherent twisted torqued” (Chinese application No: 200710072350.9) in 2007 and “Space division multiplexing Mach-Zehnder cascade type optical fiber interferometer and measurement method thereof ” (Chinese application No: 200810136824.6) in 2008, which are mainly used to solve the problem of anti-damage during the arrangement of the multiplexed fiber sensor array; the applicant disclosed “Combination measuring instrument of optical fiber Mach-Zehnder and Michelson interferometer array” (Chinese application No: 200810136819.5) and “Twin array Michelson optical fiber white light interference strain gage” (Chinese application No: 200810136820.8) in 2008, which are mainly used to solve the problem of measurement interference by the temperature in the multiplexing of the white-light optical fiber interferometer, and problem of temperature and strain being measured at the same time; the applicant disclosed “Simplifying type multiplexing white light interference optical fiber sensing demodulating equipment” (Chinese application No: 200810136826.5) in 2008 and “Distributed optical fiber white light interference sensor array based on adjustable Fabry-Perot resonant cavity (Chinese application No: 200810136833.5) in 2008, which are mainly used to simplify the topology of the multiplexed interferometer, and construct a form of common optical path to improve the temperature stability by introducing an annular chamber, F-P chamber optical path autocorrelator; the applicant disclosed “Apparatus for sensing demodulating double-datum length low coherent optical fiber ring network” (Chinese application No: 200810136821.2) in 2008, wherein a 4×4 optical fiber coupler optical path autocorrelator is proposed, aiming to solve the problem of concurrent measurement of multiple-datum sensors.

However, in the above described multiplexed interferometer based on space division multiplexing, the power attenuation of light source is high, the light source utility rate is low, only a small part of the light emitted from light source arrive the sensor array, which is received by the detector and formed an interference pattern. As for the optical path structure disclosed by W. V. Sorin, when the optical signals reflected by the sensor array go through the optical fiber coupler, only half of the light enters the Michelson autocorrelator, and another half of the light is wasted along the optical path connected to the light source. In addition, the light entered the Michelson autocorrelator, only half of them enter the photodetector when passing the coupler 2 after reflected by the mirror, and another half of the light are fed back to the coupler. Thus, in such structure, at most ¼ of the light source power makes contribution to the sensing process. If only one sensor array is included, and another output port of the coupler is not used, there is a further ½ light power attenuation, therefore the total light source utility rate is at most ⅛. In addition, the light fed by the coupler will enter into the light source directly, although the light source type is broad-band light, which is not very sensitive to the feedback compared to the laser light source, but for a significant large feedback of the signal power, especially for light source with large gain of self-radiation, such as SLD and ASE, the feedback light will cause the resonant of the light source.

In any sensing system, the effective utility rate of the light source is always a very important parameter, since it directly affects the multiplexing ability of the sensing system. Thus, there is a very significant meaning for the practical application to improve the light source utility rate of the sensing system based on white light interference. If the light source utility rate increases 3 dB, then the amount of sensors that the sensing system could multiplex could increase about one time.

### SUMMARY OF THE INVENTION

The purpose of the present invention is to provide a multiple optical channel autocorrelator based on an optical fiber circulator for sensing, which can achieve in line real time monitor and measurement for physical amount, such as multiple points strain or deformation, solve many problems as that power attenuation of light source is big, efficiency is low, the precision in measurement is degraded which is caused by the feedback light of the light source appeared in the optical path, etc, when many sensors are multiplexed in one optical fiber, and improve the stability of the system.

The purpose of the invention can be achieved as follows:

According to the present invention, the multiple optical channel autocorrelator based on an optical fiber circulator for sensing is composed of: a source for providing broad-band light, at least an optical-fiber sensor array, a double or multiple light beams generator, at least an optical fiber circulator and at least a photoelectric detector;

The optical-fiber sensor array is composed of sensing fibers with several well cut end faces connected end to end, in line partial reflective mirrors_are formed by the connecting end faces of the adjacent fibers, mirror of each part reflects part of reference light and sensing light;

The double or multiple light beams generator includes a fixed arm and an adjustable arm, an optical path difference between the fixed arm and the adjustable arm is adjustable in order to match the optical path of each sensor in the sensor array;

The optical fiber circulator couples signals generated by the double or multiple light beams generator to the sensor array, and couples signals returned by the sensor array to the photoelectric detector;

The photoelectric detector is connected to the optical fiber circulator for detecting interference signal.

The present invention is implemented by multiplexing several optical-fiber sensors into one or more sensor arrays. A partial mirror is formed at the connecting end face of two adjacent sensors. The broad-band light emitted from the light source is divided into two beams after passing the multiple light beams generator: the first beam has a fixed optical path; the second beam includes a delay line with adjustable optical path. Both beams of light signals enter optical fiber sensor array via the three-port optical fiber circulator along the same transmission path, and will be detected again by the photoelectric detector after reflected by various partial mirrors in the sensor array in turn and passing through the optical fiber circulator.

The basic components of the present invention includes: a broad-band light source, such as a Light-Emitting Diode (LED), a Super-Luminescent Diode (SLD) or an Amplified Spontaneous Emission light source (ASE); an adjustable multiple light beams generator, which includes a position-adjustable scanning mirror to generate an adjustable delay matched with the gauge of each sensor between the reference signal and sensing signal; one or more optical fiber circulators, which is used to improve the effective utilization of the optical power of the light source output, thereby improving the multiplexing capability of the sensing system; input/output optical fiber, whose length can be up to several kilometers or even longer, in order to achieve remote measurement; one or more fiber optic sensor arrays, composed of optical fibers with several fragments of well cut end faces and a certain reflectance, connected end to end, one partial mirror is formed at the connecting end face between two fragments of adjacent optical fibers; one or more photoelectric detectors for detecting interference signal.

In practical application, if the optical path of the delay line of the multiple light beams generator matches with the optical path of a certain sensor in the sensor array, than the photoelectric detector will detect the interference signal. The position of the scanning mirror is associated with the sensor's gauge. By adjusting the position of the scanning mirror to change the optical path of the delay line, it would enable delay line match with the optical path of each sensor, respectively. If the length of the optical fiber sensor is slightly different between each other, then the position of each interference fringe corresponds to the unique optical fiber sensor.

Compared to the prior art, characteristics of the present invention are mainly reflected in the follows:

1, by introducing optical fiber circulator, the effective utilization of the output power of the light source is improved, thereby improving the multiplexing capability of the sensing system.

2, by constructing an optical path structure of unidirectional transmission, it avoids the light beam fed back to the light source, to improve the stability and reliability of the measurement system.

3, by constructing a structure of entirely shared optical path, it achieves the match of entirely shared optical path of multi-scale quasi-distribution, reducing the impact brought by the optical path for the system detection.

The present invention can achieve in line real time monitor and measurement for physical amount, such as multiple points strain or deformation, solve many problems as that power attenuation of light source is big, efficiency is low, the precision in measurement is degraded which is caused by the feedback light of the light source appeared in the optical path, etc., when many sensors are multiplexed in one optical fiber, and improve the stability of the system. Using the optical path difference adjustable double-beam or multi-beam generator, it can generate two-beam or multi-beam optical path difference adjustable query beam under the help of the introduced optical path delay between the reference optical path and the sensing optical path. When the optical path difference of these different query beams is equal to the optical path between two end faces of the front and rear in some optical fiber sensor, the interference of low-coherence light can be achieved, and it can be further used to construct an optical fiber sensor array, or a distributed white light interferometer strain sensing system over the network.

### BRIEF DESCRIPTION OF THE DRAWINGS

FIG. 1 is a schematic diagram of device structure of the autocorrelator based on the optical fiber circulator of the invention, which includes an optical fiber ring-shape resonance chamber for generating at least one optical delay line.

FIG. 2 is a schematic diagram of interference signal of the autocorrelator based on the optical fiber circulator of the invention, the sensor array of the autocorrelator includes 6 optical fiber sensors.

FIG. 3 is a schematic diagram of another device structure of the autocorrelator based on the optical fiber circulator of the invention, which includes an optical fiber Fizeau interrogator for generating at least one optical delay line.

FIG. 4 is a schematic diagram of another device structure of the autocorrelator based on the optical fiber circulator of the invention, which uses an optical fiber Mach-Zehnder interrogator for generating at least one optical delay line, and includes one branch signal with fixed optical path and one branch signal with adjustable optical path. The second optical fiber coupler of the Mach-Zehnder interrogator divides the optical path delay into two branches, each connected to one optical fiber sensor array.

FIG. 5(a-d) are schematic diagrams of another device structure of the autocorrelator based on the optical fiber circulator of the invention, which uses an optical fiber Michelson interrogator for generating one optical delay line, and includes one branch signal with fixed optical path and one branch signal with adjustable optical path. FIG. 5(a) only includes one optical fiber sensor array; FIG. 5(b) is one improvement of the device shown in FIG. 5(a), which improve the multiplexing ability of the device by increasing two three-port optical fiber circulators to construct two optical fiber sensor arrays; FIG. 5(c) is one variation of the device shown in FIG. 5(b), wherein the two three-port optical fiber circulators in FIG. 5(b) are replaced with one four-port optical fiber circulator; FIG. 5(d) is one extension of the device shown in FIG. 5(b), wherein one optical fiber sensor array for quasi-distributed measurement is formed with two 1×N optical fiber couplers of star-type, several optical fiber circulators and a photoelectric detector.

### DETAILED DESCRIPTION OF THE PREFERRED EMBODIMENTS

Hereinafter, the present invention will be described in details by referring to examples of the accompanying drawings.

The detailed embodiment of the invention is based on an optical fiber circulator, which is used for distributed real time monitor and measurement for material and geometric features of the building structure, and includes one double or multiple light beams generator, and at least an optical fiber sensor array. The multiple light beams generator is used to generate sensing signal with fixed optical path and reference signal with adjustable delay line. The multiple light beams generator may has a different structure, but it at least should include an optical path fixed arm and an optical path adjustable arm, the optical path adjustable arm is composed of a Grads Refraction rate (GRIN) lens connected to the end of the optical fiber and a scanning mirror installed on a linearity shift platform. The scanning mirror is used to adjust the optical path difference between the optical path fixed arm and the optical path adjustable arm, enable it match the optical path of each optical fiber sensor.

In the device described in the invention, each optical fiber sensor actually is a fragment of optical fiber with well cut end faces. Each sensor array is composed of several fragments of optical fibers connected end to end in series; a partial mirror is formed at the connecting end between two fragments of adjacent optical fibers, such that a series of in line mirrors in parallel with each other are formed along the optical fiber. The reflectance of the mirror is small, so as to avoid the excessive attenuation of a signal transmitted in the sensor array. Both the reference signal and sensing signals are transmitted along the sensor array, and in each mirror there is a part of the signal being reflected. Reflected signal is returned along the original path, and reaches the photoelectric detector via the optical fiber circulator. If the optical path of the reference signal reflected by a near end mirror of some sensor in the sensor array is equal to the optical path of the sensing signal reflected by a far end mirror of the same sensor, then an interference signal will occur at the detector end. The position of the interference fringe is represented by the position of the scanning mirror, corresponding to the gauge of the optical fiber sensor. Therefore, it can measure any physical amount capable of causing the optical path change of the optical fiber sensor by monitoring the interference fringe.

It should be noted that, the length of all optical fiber sensors in the sensor array is approximately equal to each other, but slightly different between them. Also to be noted, in the device according to the present invention, the optical fiber directional coupler is replaced with a optical fiber circulator, which can greatly improve the effective utilization of optical power output by the light source, and improve the multiplexing capability of the sensing system.

The particular implementing mode 1:

Referring to FIG. 1, the adjustable multiple light beams generator 110 is based on a structure of optical fiber ring-shape resonator structure, and is composed of 2×2 optical fiber directional coupler 116, a three-port optical fiber circulator 111, GRIN lens 113, and a scanning mirror 115. Two ports 116c and 116d of the optical fiber coupler 116 are connected to two ports 111a and 111c of the circulator 111, respectively. The third port 111b of the circulator 111 is connected to the GRIN lens 113. The scanning mirror 115 is installed on a linearity shift platform, and enables its reflecting surface perpendicular to the optical axis of the GRIN lens 113, such that an adjustable match distance 114 is obtained between the GRIN lens 113 and the scanning mirror 115. Port 116b of the optical fiber coupler 116 is connected to port 120a of another three-port optical fiber circulator 120; another port 120b of the circulator 120 is connected to the optical fiber sensor array 140 through input/output optical fiber 130. The input/output optical fiber 130 can be as long as several kilometers or even more, for remote sensing measurement. The optical fiber sensor array 140 is composed of N optical fiber sensors S1-Sn connected end to end in series; in line partial mirrors R0-Rn are formed at the connecting end between adjacent sensors. The reflectance of the mirrors S1-Sn are small, so as to avoid the excessive attenuation of signal transmitted in the sensor array. The lengths of all optical fiber sensors S1-Sn are approximately equal to each other, but slightly different between them. The photoelectric detector 150 is connected to a third port 120c of the optical fiber circulator 120, and is used for detecting sensing optical signals and reference optical signals from the optical fiber sensor array 140, and transforming these optical signals into electric signals.

In practical practice, after the broad-band light emitted from the light source 100 (normally as SLD) entering into multiple light beams generator 110, it is divided into two beams by the optical fiber directional coupler 116: a beam of light directly enters to optical fiber sensor array 140 via the optical fiber circulator 120 as sensing light, whose transmission path is 116a-116b through the multiple light beams generator 110; the other beam of light serves as reference light, which is reflected by the scanning mirror 115 after passing the optical fiber circulator 111, and the light reflected back returns to the input terminal of the optical fiber coupler 116 through the optical fiber circulator 111 again, such that a delay line based on optical fiber ring-shape resonator is formed. The delayed reference signal is divided into two beams by the optical fiber coupler 116 again, one beam enters circulator 120 through port 116b, another beam enters circulator 111 through port 116c, repeating the process of being reflected. The reference light reflected once by the mirror 115 has a transmission path of 116a-116c-111a-111b-115-111b-111c-116d-116b; the reference light reflected twice by the mirror 115 has a transmission path of 116a-116c-111a-111b-115-111b-111c-116d-116c-111a-111b-115-111b-111c-116d-116b; and so on. As seen from that, the optical path delay of the two beams of adjacent optical signals generated by multiple light beams generator 110 is 116c-111a-111b-115-111b-111c-116d. The sensing light and reference light transmitted in senor array 140 are reflected by partial mirrors R0-Rn at both ends of each sensors S1-Sn, the reflected light enters photoelectric detector 150 along the same optical path through the optical fiber circulator 120.

In order to facilitate discussion, provided the optical path of the optical fiber sensor S1 is L1, the optical path of the optical fiber sensor S2 is L2, and so on, the optical path of the sensor Sn is Ln. Taking sensor Sj for example, a portion of the reference light enters photoelectric detector 150 after being reflected by mirror Rj-1 located in the near end of Sj, and a portion of sensing light also enters photoelectric detector after being reflected by mirror Rj located in the far end of Sj. If the optical path difference between the reference light and the sensing light arrived at the detector is less than the coherence length of the light source 100, i.e., the difference between the optical path delay 116c-111a-111b-115-111b-111c-116d of the multiple light beams generator 110 and the optical path Lj of the sensor Sj is less than the coherence length of the light source 100, the interference will occur between these two optical signals. Similarly, adjusting the position of the scanning mirror 115, such that the optical path delay of the multiple light beams generator 110 is equal to the optical path Lj+k of another sensor Sj+k, another interference pattern can be obtained at the end of the detector 150. The amplitude of the central fringe of the interference fringes is the biggest, which corresponds to the absolute equal for the optical path between the reference light and the sensing light. Therefore, it is possible to establish direct correspondence relationship between the position of interference fringes and optical fiber sensor gauge. If the gauge of each sensor in the sensor array 140 is different from each other, then each sensor corresponds to a unique interference pattern, thereby to distinguish signals from different sensors.

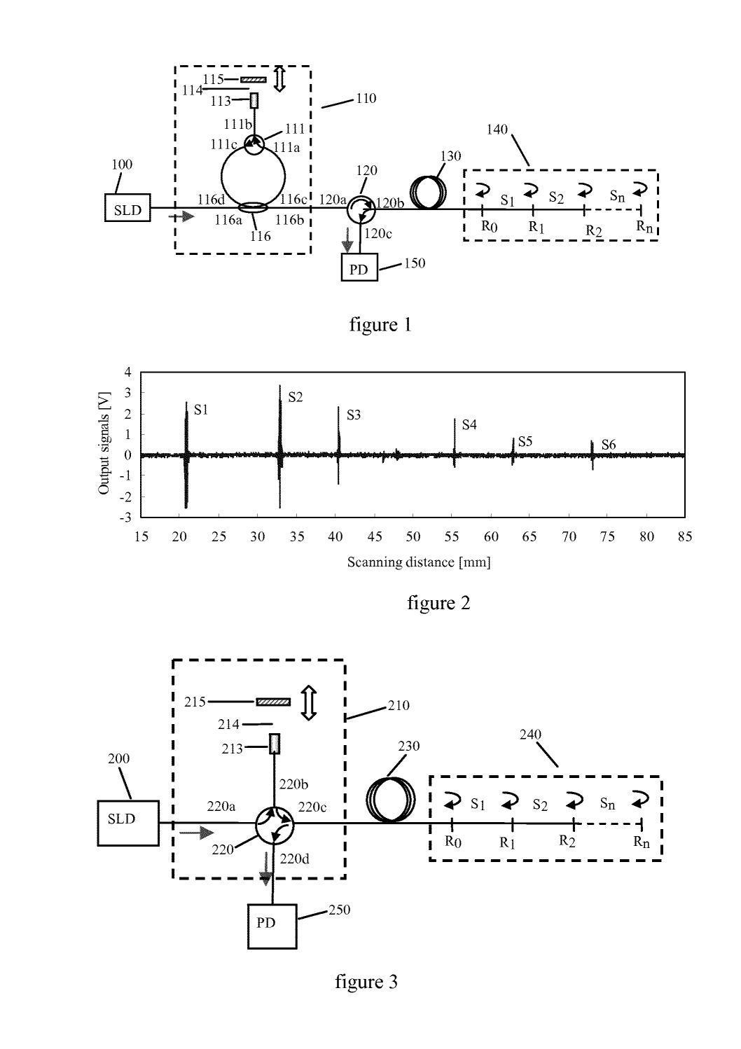

FIG. 2 is interference signal of the autocorrelator based on the optical fiber circulator of the invention. Said sensor array of the autocorrelator includes 6 optical fiber sensors, whose gauges satisfy L1<L2< . . . <L6.

It should be noted that, in the multiple light beams generator 110, a fixed length among the adjustable reference optical path is slightly less than the minimum gauge of each optical fiber sensor, and the adjustable range of scanning mirror 115 is slightly larger than the difference between the maximum gauge and the minimum gauge in the sensor. Also noted that, the smallest length difference between the gauges of optical fiber sensor is greater than the maximum deformation of the two sensors plus twice of the coherence length of the light source 100, in order to avoid the interference fringes corresponding to different sensors overlapping.

The particular implementing mode 2:

Referring to FIG. 3, the embodiment of the invention is used for measuring the change of material and geometric features of the building structure. The adjustable multiple light beams generator 210 is based on a structure of optical fiber Fizeau interrogator, which includes a GRIN lens 213 and a scanning mirror 215. The connection manner for each port of a four-port optical fiber circulator 220 is: port 220a is connected to light source 200, port 220b is connected to the GRIN lens 213 in the multiple light beams generator 210, port 220c is connected to the optical fiber sensor array 240 through input/output optical fiber 230, port 220d is connected to the photoelectric detector 250. The up surface of the GRIN lens 213 is of a certain reflection rate and transmission rate, and the reflection rate and transmission rate can be chosen according to the needs. The scanning mirror 215 is installed on a linearity shift platform, and enables its reflecting surface perpendicular to the optical axis of the GRIN lens 213, such that an adjustable match distance 214 is obtained between the GRIN lens 213 and the scanning mirror 215. The optical fiber sensor array 240 is composed of N optical fiber sensors S1-Sn connected end to end in series; in line partial mirrors R0-Rn are formed at the connecting end between adjacent sensors. The reflectances of mirrors R0-Rn are small so as to avoid the faster attenuation of the signal transmission in the sensor array. Said optical fiber sensors S1-Sn are composed of optical fibers with several fragments of well cut end faces and a certain reflectance, wherein the lengths of each optical fiber are different from each other, but approximately equal.

In practical practice, the broad-band light emitted from the light source 200 (normally as SLD) enters into multiple light beams generator 210 through ports 220a and 220b of the circulator 220, which has been divided into two beams by GRIN lens 213: a beam of light serves as sensing signal, which has been reflected by the upward surface of the GRIN lens 213, and entered into the input/output optical fiber 230 through ports 220b and 220c of the circulator 220; the other beam of light serves as reference signal, which is reflected by the scanning mirror 215 after passing through the GRIN lens 213 and then returned to the GRIN lens 213, and the returned light is further divided into two beams on the surface of the GRIN lens 213, wherein one beam is transmitted through GRIN lens 213, enters into the input/output optical fiber 230 through ports 220b and 220c of the circulator 220; the other part of light arrives the scanning mirror 215 again after reflected by the up surface of the GRIN lens 213, once again, and reaches the GRIN lens 213 after being reflected, and so on, so a series of signals having the same optical path difference are generated. The optical path difference between the light reflected once by the scanning mirror 215 and the light directly reflected by the GRIN lens 213 is 2X (X is the optical path of the adjustable distance 214), the optical path difference between the light reflected twice and the light reflected once by the scanning mirror 215 is also 2X, and so on, the optical path difference between the light reflected k+1 times and the light reflected k times by the scanning mirror 215 is also 2X. The size of optical path difference 2X can be changed by adjusting the position of the scanning mirror 215.

Similar to the above discussion in FIG. 1, provided the optical path of the optical fiber sensor S1 is L1, the optical path of the optical fiber sensor S2 is L2, and so on, the optical path of the sensor Sn is Ln. Also taking sensor Sj for example, a portion of the reference light enters photoelectric detector 250 after being reflected by mirror Rj-1 located in the near end of Sj, and a portion of sensing light also enters photoelectric detector 250 after being reflected by mirror Rj located in the far end of Sj. If the optical path difference between the reference light and the sensing light arrived at the detector 250 is less than the coherence length of the light source 200, i.e., the difference between the adjustable optical path X of the multiple light beams generator 210 and optical path Lj, is less than the coherence length of the light source 200, the interference will occur between these two optical signals. Similarly, adjusting the position of the scanning mirror 215, such that the adjustable optical path X in the multiple light beams generator 210 is equal to the optical path Lj+k of another sensor Sj+k, another interference pattern can be obtained at the end of the detector 250. The amplitude of the central fringe of the interference fringes is the biggest, which corresponds to the absolute equal for the optical path between the reference light and the sensing light. Therefore, it is possible to establish direct correspondence relationship between the position of interference fringes and optical fiber sensor gauge. If the gauge of each sensor in the sensor array 240 is different from each other, then each sensor corresponds to a unique interference pattern.

The particular implementing mode 3:

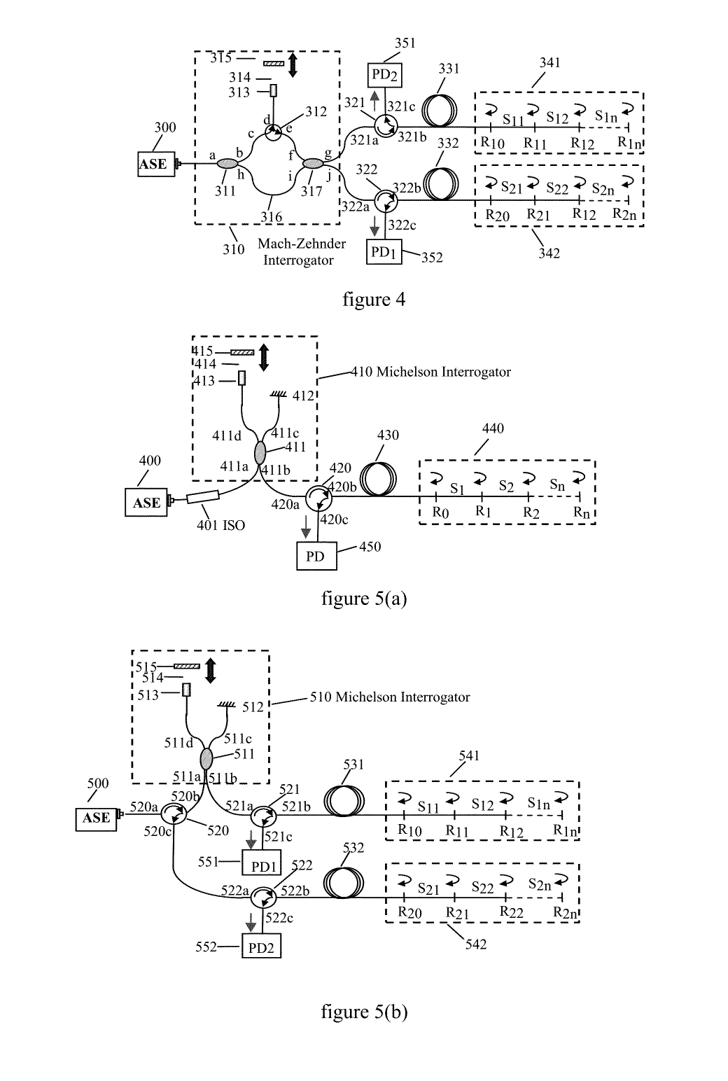

Referring to FIG. 4, to improve the multiplexing capability of the device of the present invention, the adjustable double light beams generator 310 is based on a structure of optical fiber Mach-Zehnder interrogator, which includes a 1×2 optical fiber directional coupler 311, a 2×2 optical fiber directional coupler 317, a three-port optical fiber circulator 312, a GRIN lens 313 and a scanning mirror 315. One output port h of the optical fiber coupler 311 is directly connected to one input port i of the optical fiber coupler 317, forming one fixed arm 316 of the optical path as part of the sensing optical path; another output port b of the optical fiber coupler 311 and the second input port f of the optical fiber coupler 317 are connected to two ports c and e of the optical fiber circulator 312, respectively, as part of the reference optical path. A third port d of the circulator 312 is connected to GRIN lens 313, receiving the optical signal reflected from the scanning mirror 315. The scanning mirror 315 is installed on a linearity shift platform, and enables its reflecting surface perpendicular to the optical axis of the GRIN lens 313, such that an adjustable match distance 314 is obtained between the GRIN lens 313 and the scanning mirror 315.

Two output ports g and j of the optical fiber coupler 317 are connected to input ports 321a and 322a of the optical fiber circulators 321 and 322, respectively, ports 321b and 322b are connected to the sensor arrays 341 and 342 through input/output optical fibers 331 and 332, respectively. The sensor array 341 is composed of N optical fiber sensors S11-S1n connected end to end in series; in line partial mirrors R10-R1n are formed at the connecting end between adjacent sensors. Similarly, sensor array 342 is composed of M (may be the same as N) optical fiber sensors S21-S2m connected end to end in series, in line partial mirrors R20-R2m are formed at the connecting end between adjacent sensors. The reflectances of all mirrors are small so as to avoid the faster attenuation of the signal transmission in the sensor array. The lengths of all optical fiber sensors are approximately equal to each other, but slightly different between them. The photoelectric detectors 351 and 352 are connected to ports 321c and 322c, for receiving sensing optical signals and reference optical signals from the optical fiber sensor arrays 341 and 342, and transforming these optical signals into electric signals.

It should be noted that, as for the autocorrelator based on the Mach-Zehnder interrogator shown in FIG. 4, if not considering the loss of various components themselves in said device and the insertion loss at connecting point, at almost the effective utilization of the optical power output by the light source can reach 100%, so the multiplexing capability of said device has been greatly improved.

In practical practice, the broad-band light emitted from the light source 300 (normally as ASE) enters into optical fiber coupler 311, after that, it has been divided into two beams: one beam of light serves as sensing light, which directly passes the optical fiber coupler 317 along the ports b and i, again it has been divided into two beams, which enter the optical fiber sensor arrays 341 and 342 through optical fiber circulator 321 and 322, respectively; the other beam of light serves as reference light, which is reflected by the scanning mirror 315 after passing through the ports c and d of the optical fiber circulator 312, the light reflected back arrives the optical fiber coupler 317 via ports d and e of the optical fiber circulator 312, which is divided into two beams by the coupler 317, similarly, which enter the optical fiber sensor arrays 341 and 342 through optical fiber circulator 321 and 322, respectively. After the reference light and sensing light entered the optical fiber sensor array 341 are reflected by the partial reflecting faces R10-R1n, they enter photoelectric detector 351 via circulator 321. Similarly, after the reference light and sensing light entered the optical fiber sensor array 341 are reflected by the partial reflecting faces R20-R2m, they enter photoelectric detector 352 via circulator 322.

For the convenience of discussion, provided the optical path of the optical fiber sensor S11 is L11, the optical path of the optical fiber sensor S12 is L12, and so on. Taking sensor S11 for example, a portion of the reference light enters photoelectric detector 351 after being reflected by mirror R10 located in the near end of S11, and a portion of sensing light also enters photoelectric detector 351 after being reflected by mirror R11 located in the far end of S11. If the difference between the optical path difference of two arms of the Mach-Zehnder interrogator and L11 is less than the coherence length of the light source 300, the interference will occur between these two optical signals. Similarly, adjusting the position of the scanning mirror 315, such that the optical path difference of two arms of the Mach-Zehnder interrogator is equal to L12, another interference pattern can be obtained at the end of the detector 351. The amplitude of the central fringe of the interference fringes is the biggest, which corresponds to the absolute equal for the optical path between the reference light and the sensing light. Therefore, it is possible to establish direct correspondence relationship between the position of interference fringes and optical fiber sensor gauge. If the gauge of each sensor in the sensor array 341 and 342 are different from each other, then each sensor corresponds to a unique interference pattern.

The particular implementing mode 4:

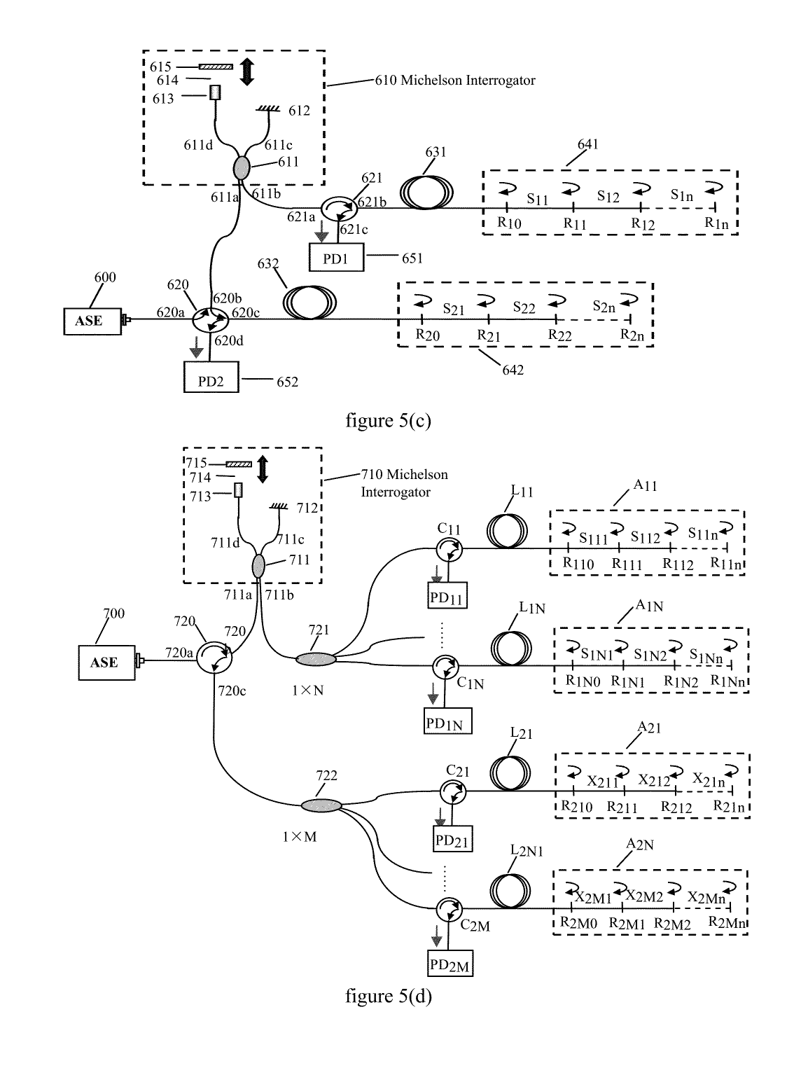

Another particular embodiment of the invention is shown in FIG. 5(a), which is used for measuring the change of material and geometric features of the building structure. The adjustable double light beams generator 410 of the device shown in FIG. 5(a) is based on a structure of optical fiber Michelson interrogator, which includes a 2×2 optical fiber directional coupler 411, a fixed mirror 412, a GRIN lens 413 and a scanning mirror 415. An end face of port 411c of the coupler 411 is stuck to the mirror 412, forming a part of the sensing arm of the fixed optical path. The method to implement the mirror 412 is to plate the end face of the optical fiber arm 411c with a layer of metal film. Serving as part of the reference arm, an end face of another port 411d of the optical fiber coupler 411 is connected to the GRIN lens 413 for receiving optical signals reflected by the scanning mirror 415. The scanning mirror 415 is installed on a linearity shift platform, and enables its reflecting surface perpendicular to the optical axis of the GRIN lens 413, such that an adjustable match distance 414 is obtained between the GRIN lens 413 and scanning mirror 415.

Port 411b of the optical fiber coupler 411 is connected to a port 420a of the circulator 420, another port 420b of the circulator 420 is connected to the sensor array 440 through input/output optical fiber 430, the input/output optical fiber 430 can be as long as several kilometers or even more, for remote sensing measurement. The optical fiber sensor array 440 is composed of N optical fiber sensors S₁-Sₙ connected end to end in series, in line_partial mirrors R₀-Rₙ are formed at the connecting end between adjacent sensors. The reflectance of the mirrors S₁-Sₙ are small, so as to avoid the excessive attenuation of signal transmitted in the sensor array 440. The lengths of optical fiber sensors S₁-Sₙare approximately equal to each other, but slightly different among them. The photoelectric detector 450 is connected to port 420c of the optical fiber circulator 420, and is used for receiving sensing optical signals and reference optical signals from the optical fiber sensor array 440, and transforming these optical signals into electric signals.

In real practice, optical source 400 (general as ASE light source) is connected to optical fiber directional coupler 411 through a optical fiber isolator 401. The broad-band light emitted from the light source 400 is divided into two beams by the optical fiber coupler 411: a beam of light serves as sensing signal, which is reflected by the mirror 412 after passing the optical fiber arm 411c; the other beam of light serves as reference signal, which is reflected by the scanning mirror 415 after passing the optical fiber arm 411d and GRIN lens 413. The sensing signal and the reference signal reflected back are divided into two beams by the optical fiber coupler 411 again: a beam of light enters the isolator 401 along port 411a and is attenuated therein; another light beam enters optical fiber circulator 420 through port 411b, and then it enters the optical fiber sensor array 440 through the input/output optical fiber 430, after reflected by the partial mirrors R₀-Rₙ, it returns and enters the photoelectric detector 450 through the optical fiber circulator 420 along the original path.

Similarly, provided the optical path of the optical fiber sensor S1 is L1, the optical path of the optical fiber sensor S2 is L2, and so on. the optical path of the optical fiber sensor Sn is Ln. Taking sensor Sj for example, a portion of the reference light enters photoelectric detector 450 after being reflected by mirror Rj-1 located in the near end of Sj, and a portion of sensing light also enters photoelectric detector 450 after being reflected by mirror Rj located in the far end of Sj. If the Optical Path Difference OPD of two arms of the Michelson interrogator 410 is equal to Lj, interference fringes will be obtained at the detector 450. If adjusting the position of the scanning mirror 415, such that the Optical Path Difference OPD of two arms of the Michelson interrogator 410 is equal to optical path L2 of another sensor Sj+k, another interference pattern can be obtained at detector 450. The amplitude of the central fringe of the interference fringes is the biggest, which corresponds to the absolute equal for the optical path between the reference light and the sensing light. Therefore, it is possible to establish direct correspondence relationship between the position of interference fringes and optical fiber sensor gauge. If the gauge of each sensor in the sensor arrays 341 and 342 are different from each other, then each sensor corresponds to a unique interference pattern.

It should be noted that, in the device shown in FIG. 5(a), since the optical fiber circulator 420 instead of the optical fiber directional coupler being used, such that the coupling efficiency of said device has been improved by about 3 dB, this means that SNR of said device is improved 3 dB, thus greatly improving the multiplexing capability of said device for the sensor.

Although the device described in FIG. 5(a) can improve the utilization of the light source and the multiplexing capability of the system, there is still loss of about 3 dB in the optical fiber coupler 411. This is because when the signals reflected by the mirrors 415 and 412 go through the optical fiber coupler 411, only half of the power enters the fiber optic sensor array 440 through the optical fiber circulator 420 along the port 411b of the coupler 411, while the other half of the power is worn out when entering isolator 401 through port 411a, making no contribution to the sensing system.

In order to further improve the effective utilization of the light source output power of said device, another embodiment based on Michelson interrogator is shown in FIG. 5(b). In the device shown in FIG. 5(b), the structure of the double optical beams generator 510 is the same as that of the generator 410 in FIG. 5(a). The difference lies in that, the device described in FIG. 5(b) uses a three-port optical fiber circulator 520 to replace the optical fiber isolator 401 of the device of FIG. 5(a). One port 520a of the circulator 520 is connected to the light source 500, another port 520b is connected to the input port 511a of the double optical beams generator 510, a third port 520c is connected to port 522a of another three-port optical circulator 522. Another port 522b of the circulator 522 is connected to another optical fiber sensor array 542 via input/output optical fiber 532, port 522c is connected to the photoelectric detector 552. For the optical signal reflected by mirrors 512 and 515, one part enters sensor array 542 via circulator 520 and 522 through the input port 301a of the optical fiber coupler 301, and returns back following the original path after being reflected by the partial reflecting face of the sensor array 542, and again it is detected by the photoelectric detector 552 via circulator 522. The connecting manner for another port 511b of the double optical beams generator 510 is the same as that of the device in FIG. 5(a), wherein it is connected to the sensor array 541 through the circulator 521 and input/output optical fiber 531, and returns back following the original path after being reflected by the reflecting face of the sensor array 541, and enters the photoelectric detector 551 via port 521c of the circulator 521.

Note that, in the device shown in FIG. 5(b), since the optical fiber circulator 520 is inserted between the light source 500 and the double optical beams generator 510, and another optical fiber sensor array 541 is connected to the circulator 520, so that the utilizing rate of said light source in the device further increase one times on the basis of the device shown in FIG. 5(a). Therefore, under the same optical power output, the multiplexing capability of the sensing system is further improved.

Using a four-port optical fiber circulator 620 instead of two three-port optical fiber circulators 520 and 522 in the device shown in the FIG. 5(b), the device shown in FIG. 5(b) can be further simplified. The structure schematic diagram of the simplified device is shown in FIG. 5(c), wherein the sensing principle is basically same as that of the device shown in FIG. 5(b). The only difference is that, two three-port optical fiber circulators 520 and 522 of the device shown in FIG. 5(b) are replaced by a four-port optical fiber circulator 620. The role of four-port optical fiber circulator 620 is to achieve the followings simultaneously, coupling the broad-band light emitted from light source 600 into the double optical beams generator 610, coupling part of the light reflected by the scan mirror 615 and 612 into the optical fiber sensor array 642, coupling the reflecting signal modulated by the sensor array 642 into photoelectric detector 652.

The advantage of using the four-port optical fiber circulator 620 is, the complexity of the device shown in the FIG. 5(b) can be reduced, thereby improving the reliability of the device. The use of the four-port optical fiber circulator 620 instead of the three-port optical fiber circulator 550 and 552 can also reduce the insertion loss of the device.

In order to further improve the multiplexing capability of the Michelson interrogator-based sensor system, M×N sensor matrix can be formed by using two optical fiber couplers of star-type 721 and 722, the structure schematic diagram of said device is shown in FIG. 5(d). The structure of the double optical beams generator 710 is the same as that of the double optical beams generator 410 shown in FIG. 5(a). One port 711b of the optical fiber directional coupler 711 is directly connected to an input port of the 1×N star-type coupler 721, another port 711a of the coupler 711 is connected to 1×M star-type coupler 722 through a three-port optical fiber circulator 720. The third port 720a of the circulator is connected to the source 700. Each output arm of the star-type coupler 721 and 722 is connected to an optical fiber sensor array Aᵢⱼ through an optical fiber circulator Cᵢⱼ and input/output optical fibers Lᵢⱼ. Each sensor array comprises a plurality of optical fiber sensors cascaded connected in series, an in line partial mirror is formed at the connecting end of the adjacent sensors. The reflectance of the mirror is small, so as to avoid the excessive attenuation of a signal transmitted in the sensor array Aᵢⱼ. The length of each optical fiber sensor is approximately equal, but slightly different among them. Each photoelectric detector PDᵢⱼ is connected to one optical fiber circulator Cᵢⱼ, for detecting sensing optical signals and reference optical signals from the optical fiber sensor arrays Aᵢⱼ, and transforming these optical signals into electric signals.

In real practice, the broad-band light emitted from the light source 700 (general as ASE light source) is divided into two beams by the optical fiber directional coupler 717: a beam of light serves as sensing signal, which is reflected by the fixed mirror 712 after passing the port 711c; the other beam of light serves as reference signal, which is reflected by the scanning mirror 715 after passing the port 711d and GRIN lens 713. The reflected sensing signal and the reference signal are divided into two beams by the optical fiber coupler 717 again: one part of light directly enters the star-type optical fiber coupler 721 along port 711b, and is divided into N beams, each beam of light all enter sensor array A₁ⱼ through optical fiber circulator C₁ⱼ, the reflected signal enters the photoelectric detector PD₁ⱼ through the optical fiber circulator C₁ⱼ again after modulated by sensor array A₁ⱼ; another part of light is transmitted along port 711a, enters the star-type coupler 722 after passing the optical fiber circulator 721, and is divided into M beams, each beam of light all enter sensor array A₂ⱼ through optical fiber circulator C₂ⱼ, the reflected signal enters the photoelectric detector PD₂ⱼ through the optical fiber circulator C₂ⱼ again after modulated by sensor array A₂ⱼ.

Note that for the Michelson interrogator-based sensor matrix shown in FIG. 5(d), if not considering the loss itself of each element consisted of the device and connecting insertion loss, the effective utilization of the light source output optical power can reach 100%. Also be aware of that, by using the 1×N optical fiber coupler of star-type, the multiplexing capability of said device can be greatly improved, such that a distributed sensor matrix may be configured for grid-like measurement.

What is claimed is:

1. A multiple optical channel autocorrelator based on optical fiber circulator for sensing, characterized in that, comprising: a source for providing broad-band light, at least an optical-fiber sensor array, an adjustable multi-beam generator, at least an optical fiber circulator and at least a photoelectric detector;
the optical-fiber sensor array is composed of several sensing fibers with good end-cutting connected end to end, in line partial reflective mirrors are formed at the connecting end faces of the adjacent fibers and mirrors of each part reflect part of reference light and sensing light;
the adjustable multiple light beams generator includes a fixed arm and an adjustable arm, an optical path difference between the fixed arm and the adjustable arm is adjustable in order to match the optical path of each sensor in the sensor array;
the optical fiber circulator couples signals generated by the dual-beam the multi-beam generator into the sensor array, and couples signals returning from the sensor array into the photoelectric detector;
the photoelectric detector is connected to the optical fiber circulator, for detecting interference signal, wherein, the optical-fiber sensor array is composed of N optical-fiber sensors connected end to end in series, the in line partial reflective mirrors are formed at the connecting ends of the adjacent fibers, wherein N is a positive integer larger than 2,
Wherein, the adjustable multi-beam generator is based on a structure of optical fiber Michelson interferometer and includes an optical fiber coupler, a fixed mirror, GRIN lens and a scanning mirror; sticking the mirror at the end face of c port of the optical fiber coupler forms a part of the sensing arm with a fixed optical path; serving as part of the reference arm, an end face of d port of the optical fiber coupler is connected to GRIN lens, for receiving optical signals reflected by the scanning mirror; the scanning mirror is installed on a linearity shift platform, and enables its reflecting surface to be perpendicular to the optical axis of the GRIN lens, such that an adjustable match distance is obtained between the GRIN lens and the scanning mirror; b port of the optical fiber coupler is connected to a port of the optical fiber circulator, b port of the optical fiber circulator is connected to the sensor array through input/output optical fiber; photoelectric detector is connected to c port of the optical fiber circulator; optical source is connected to optical fiber coupler through an optical fiber isolator.

2. The multiple optical channel autocorrelator based on optical fiber circulator for sensing as claimed in claim 1, characterized in that
the first port of the first optical fiber circulator is connected to a light source, the second port of the first optical fiber circulator is connected to the input port of the dual-beam generator, the third port of the first optical fiber circulator is connected to the first port of the third optical fiber circulator, the second port of the third optical fiber circulator is connected to the second optical fiber sensor array via an input/output optical fiber, the third port of the third optical fiber circulator is connected to the second photoelectric detector;
For the optical signal reflected by the first mirror and the second mirror, one part enters the second sensor array via the first circulator and the third circulator through the input port of the optical fiber coupler, and returns back following the original path after being reflected by the partial reflecting faces of the sensor array, and again it is detected by the second photoelectric detector via the third circulator; the connecting manner for the other port of the dual-beam generator is the same, wherein it is connected to the first sensor array through the second circulator and an input/output optical fiber, and returns back following the original path after being reflected by the reflecting face of the sensor array, and enters the first photoelectric detector via the third port of the first circulator.

3. The multiple optical channel autocorrelator based on optical fiber circulator for sensing as claimed in claim 2, characterized in that
a four-port optical fiber circulator instead of the first three-port optical fiber circulators and the third three-port optical fiber circulators, the role of the four-port optical fiber circulator is to achieve the followings simultaneously, coupling the broad-band light emitted from a light source into the dual-beam generator, coupling part of the light reflected by the scan mirror and the mirror into the optical fiber sensor array, coupling the reflecting signal modulated by the sensor array into the photoelectric detector.

4. The multiple optical channel autocorrelator based on optical fiber circulator for sensing as claimed in claim 2, characterized in that
an M×N sensor matrix is formed by using the first star optical fiber couplers and the second star optical fiber couplers; the second port of the optical fiber coupler is directly connected to the input port of the 1×N star coupler, the first port of the optical fiber coupler is connected to a 1×M star-type coupler through the first three-port optical fiber circulator; the first port of the optical fiber circulator is connected to the light source; each output arm of the first star optical fiber couplers and the second star optical fiber couplers is connected to an optical fiber sensor array (Aᵢⱼ) through an optical fiber circulator (Cᵢⱼ) and an input/output optical fibers (Lᵢⱼ); each sensor array comprises a plurality of optical fiber sensors connected in series, an in line partial mirror is formed at the connecting end of the adjacent sensors; the reflectance of the mirror is small, so as to avoid the excessive attenuation of a signal transmitting in the sensor array (Aᵢⱼ); the length of each optical fiber sensor is approximately equal, but slightly different; each photoelectric detector (PDᵢⱼ) is connected to one optical fiber circulator (Cᵢⱼ), for detecting sensing optical signals and reference optical signals from the optical fiber sensor arrays (Aᵢⱼ), and transforming these optical signals into electric signals.
